(19) United States
(12) Patent Application Publication
(10) Pub. No.: US 2009/0269023 A1
(43) Pub. Date: Oct. 29, 2009

(54) METHODS AND APPARATUSES FOR DV (DIGITAL VIDEO) DUBBING WITHOUT FRAME LOSS

(75) Inventor: Chun-Hsiung Hu, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/110,266

(22) Filed: Apr. 25, 2008

(51) Int. Cl. H04N 5/93

(52) U.S. Cl. 386/52; 386/E05.028

(57) ABSTRACT

Methods for dubbing content recorded on a tape in a DV (digital video) camera to a DVD disc by a DVD recording device comprise the following steps. A dubbing request is received. The DV camera is directed to move the tape toward the beginning of the tape by issuing a control command to the DV camera after receiving the dubbing request. It is periodically determined whether the DVD recording device and the DVD disc are ready to record data. A dubbing process is activated for recording the content from the tape on the DVD disc after determining the DVD recording device and the DVD disc are ready to record data.

### BACKGROUND

The invention relates to DV (digital video) dubbing, and more particularly, to methods and apparatuses for DV dubbing without frame loss.

DV recorders may record YCbCr 720×480 frames to conform to the NTSC (National TV Standards Committee) specification or YCbCr 720×576 frames for the PAL/SECAM (Phase Alternating Line/Sequential Couleur Avec Memoire) specification. DV recorders may record two digital audio channels (also called stereo) at 16 bit resolution and 44.1 kHz sampling rate, or 4 digital audio channels at 12 bit resolution and 32 kHz sampling rate. These captured frames and audio channels may be recorded on ¼″ (6.35 mm) metal evaporated tape and enclosed in one of two cassette formats, standard full-size DV cassettes (125×78×14.6 mm) that typically hold about three hours of digital AV data, and MiniDV cassettes (66×48×12 mm) that typically hold about one-hour of digital AV data. The smaller MiniDV cassettes have enabled camcorders to shrink to handheld proportions. The recorded frames can also be dubbed from metal evaporated tape in DV or MiniDV cassettes (i.e. DV tape or MiniDV tape) to other storage media such as hard disks, optical rewritable disks, flash memory devices and others.

### SUMMARY

Methods for dubbing content recorded on a tape in a DV (digital video) camera to a DVD disc by a DVD recording device are provided. An embodiment of a method for dubbing content comprises the following steps. A dubbing request is received. The DV camera is directed to move the tape toward the beginning of the tape by issuing a control command to the DV camera after receiving the dubbing request. It is periodically determined whether the DVD recording device and the DVD disc are ready to record data. A dubbing process is activated for recording the content from the tape on the DVD disc after determining the DVD recording device and the DVD disc are ready to record data.

Methods for dubbing content recorded on a tape in a DV camera to a storage medium by a recording device, performed by a DVR (digital video recorder), are provided. An embodiment of a method for dubbing content recorded on a tape comprises the following steps. A dubbing request is received. The DV camera is directed to move the tape toward the beginning of the tape by issuing a control command to the DV camera after receiving the dubbing request. It is periodically determined whether the recording device of the DVR, or the storage medium installed or loaded by the recording device is ready to record data. A dubbing process is activated for recording the content from the tape on the storage medium after determining the recording device or the storage medium is ready to record data.

Apparatuses for dubbing content recorded on a tape in a DV camera are provided. An embodiment of an apparatus comprises a storage medium, a recording device, and a processing unit. The recording device loads or installs the storage medium. The processing unit receives a dubbing request, directs the DV camera to move the tape toward the beginning of the tape by issuing a control command to the DV camera after receiving the dubbing request, periodically determines whether the recording device or the storage medium is ready to record data, and activates a dubbing process for recording the content from the tape on the storage medium after determining the recording device or the storage medium is ready to record data.

### BRIEF DESCRIPTION OF THE DRAWINGS

The invention can be more fully understood by reading the subsequent detailed description and examples with references made to the accompanying drawings, wherein:

FIG. 1 is a diagram of a DV (digital video) camera connecting to a DVR (digital video recorder) via a IEEE 1394 link;

FIG. 2 is a diagram of the data structure of exemplary AV/C command frames;

FIG. 3 is a diagram of the data structure of exemplary AV/C response frames;

FIG. 4a is a diagram illustrating an exemplary immediate transaction;

FIG. 4b is a diagram illustrating an exemplary deferred transaction;

FIG. 5 is a diagram of the architecture of an embodiment of a DVR;

FIG. 6 is a flowchart illustrating an embodiment of a method for DV dubbing without frame loss.

### DETAILED DESCRIPTION

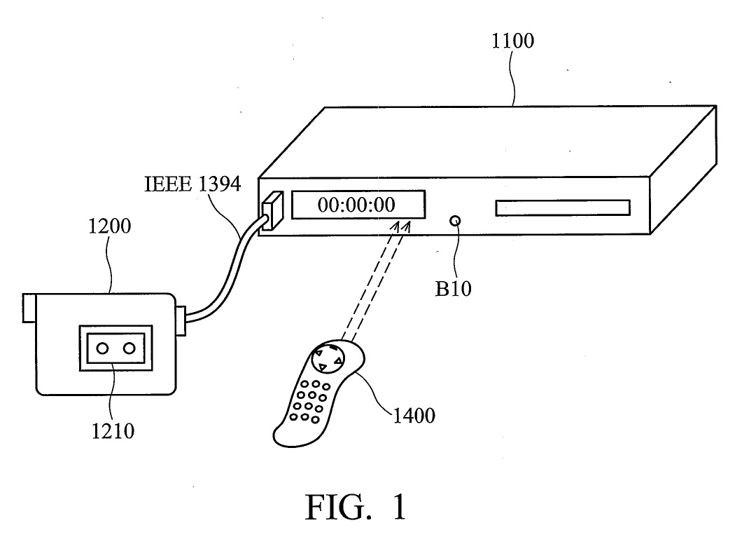

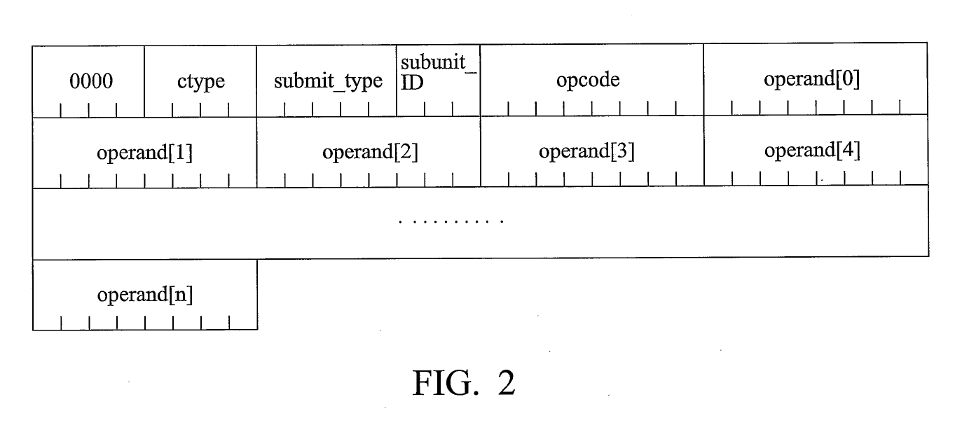

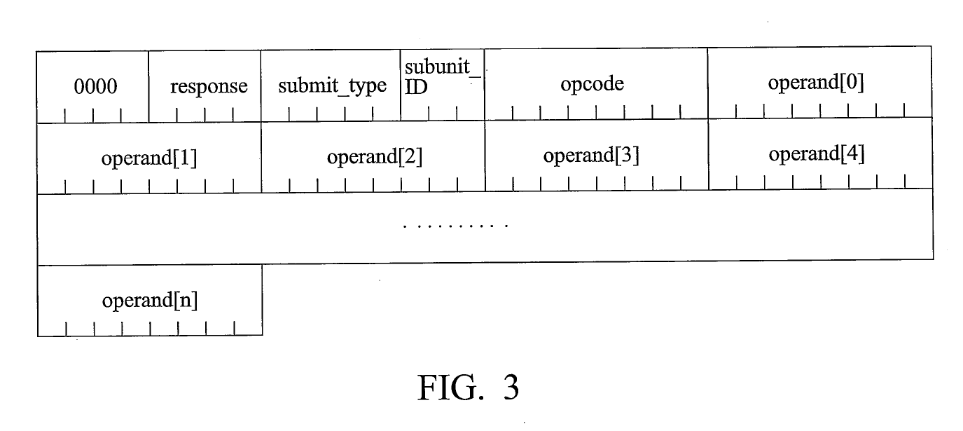

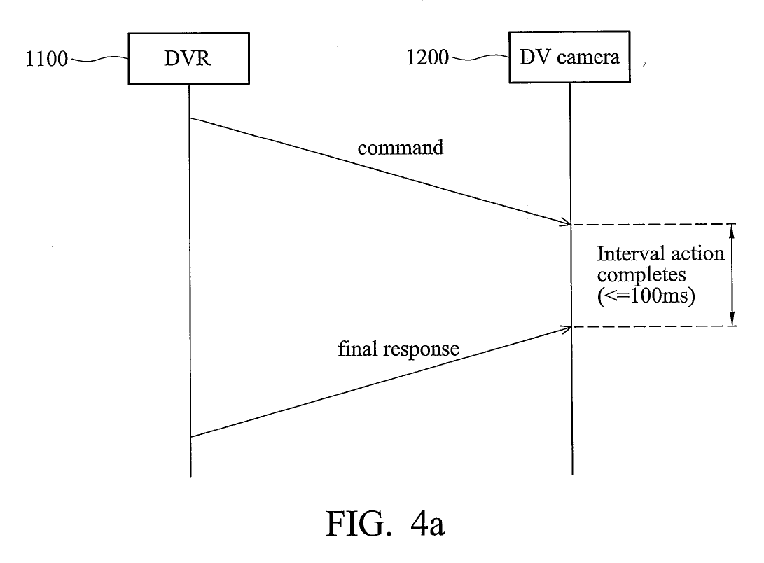

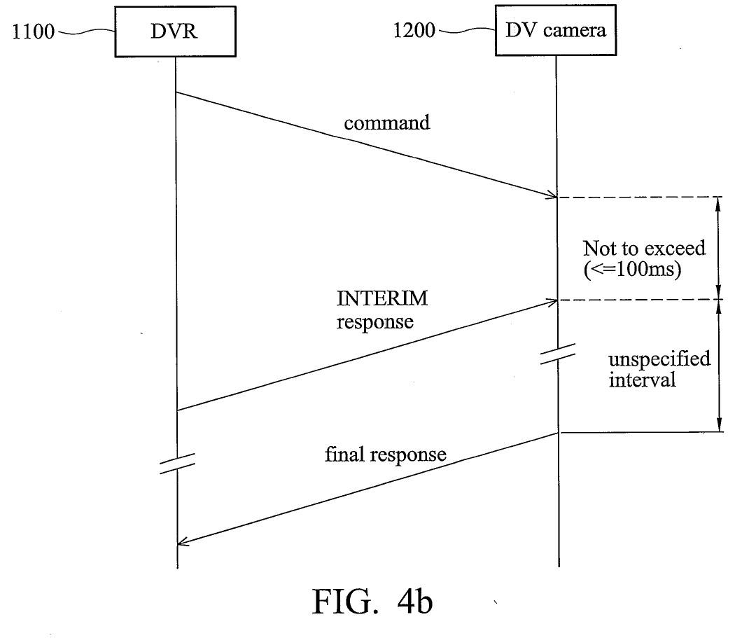

FIG. 1 is a diagram of a DV (digital video) camera 1200 connecting to a DVR (digital video recorder) 1100 via a IEEE 1394 link. Those skilled in the art may realize that the connection between the DV camera 1200 and DVR 1100 via another link, such as USB (Universal Serial Bus), IEEE 1284 link, or similar. The DV camera 1200 comprises DV/MiniDV tape 1210 recording video frames, such as YCbCr 720×480 frames for the NTSC (National TV Standards Committee) specification, YCbCr 720×576 frames for the PAL/SECAM (Phase Alternating Line/SEquential Couleur Avec Memoire) specification, or similar, and/or audio channels, such as two digital audio channels (also called stereo) at 16 bit resolution and 44.1 kHz sampling rate, 4 digital audio channels at 12 bit resolution and 32 kHz sampling rate, or similar. Those skilled in the art may use another kind of tape to record video frames and/or audio channels, such as VHS, Beta tape, or similar. When connecting to the DVR 1100, the recorded digital video frames and/or audio channels can be transmitted to the DVR 1100. The DVR 1100 can also issue AV/C digital interface commands to direct the DV camera 1200 to perform certain tasks. FIG. 2 is a diagram of the data structure of exemplary AV/C command frames. An AV/C command frame contains up to 512 bytes. All of the operands are optional and are defined based on the values of three fields: “ctype”, “subunit_type” and “opcode”. FIG. 3 is a diagram of the data structure of exemplary AV/C response frames. An AV/C response frame also contains up to 512 bytes. All of the operands are optional and are defined based on the values of three fields: “response”, “subunit_type” and “opcode”. FIG. 4a is a diagram illustrating an exemplary immediate transaction. An immediate transaction is a transaction where the DC camera 1200 is able to execute the entire transaction within 100 milliseconds. For some AV/C digital interface command transactions, the DV camera 1200 may not be able to complete the request within the 100 milliseconds. FIG. 4b is a diagram illustrating an exemplary deferred transaction. The DV camera 1200 returns an INTERIM response with the expectation that a final response (ACCEPTED or REJECTED) will follow. The details of the AV/C digital interface commands may follow the specifications established in TA Document 1998002, entitled AV/C Digital Interface Command Set—VCR Subunit Specification version 2.0.1, established Jan. 5, 1998, and TA Document 1999026, entitled AV/C Digital Interface Command Set General Specification Version 4.0, established Jul. 23, 2001. Various commands supported by another specification may also be available to direct the DV camera 1200 to perform certain tasks.

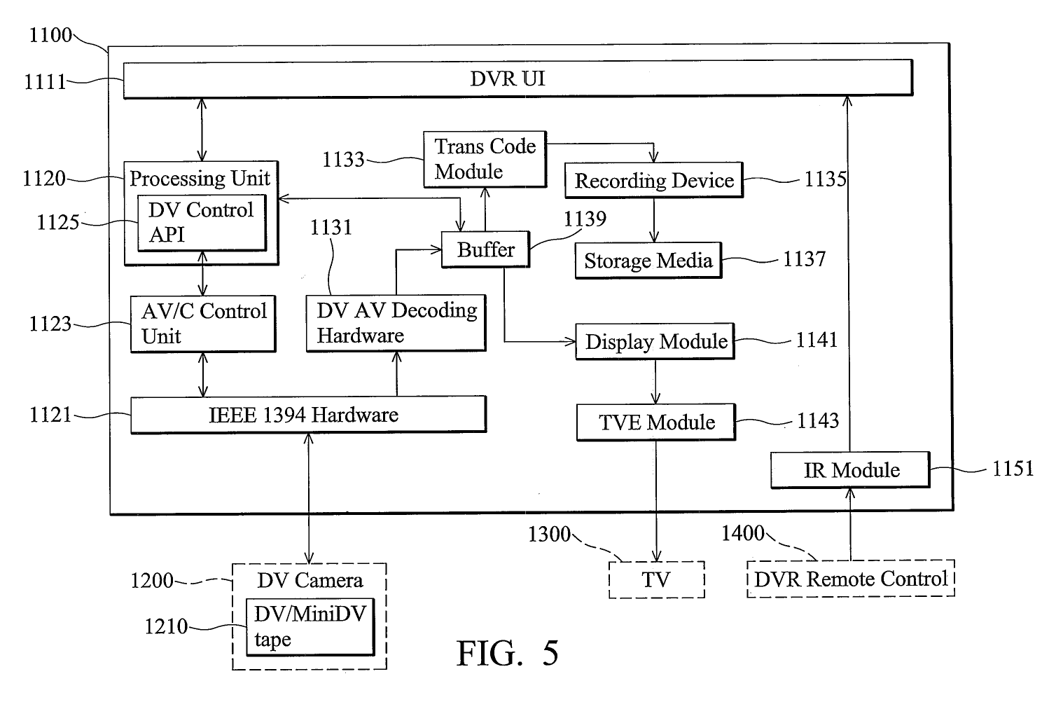

FIG. 5 is a diagram of the architecture of an embodiment of a DVR 1100. The DVR 1100 mainly comprises a DVR UI (user interface) 1111, a processing unit 1120, IEEE 1394 hardware 1121, an AV/C control unit 1123, a DV control API (application programming interface) 1125, DV AV (audio video) decoding hardware 1131, a trans code module 1133, a recording device 1135, storage media 1137, a buffer 1139, a display module 1141, a TVE (television encoding) module 1143, and an IR (infrared receiver) module 1151. The DVR UI 1111 may provide a button B10 (FIG. 1) disposed on the front panel of an enclosure of the DVR 1100, and, when detecting the button B10 is pressed, the processing unit 1120 determines that a DV dubbing procedure is requested by a user to dub video frames and/or audio channels from the DV/MiniDV tape 1210 in the DV camera 1200. The DVR UI 1111 may connect to the IR module 1151, and when the IR module 1151 receives infrared signals indicating that a DV dubbing procedure is triggered by a user from a DVR remote control 1400, the IR module 1151 notifies the processing unit 1120 that the dubbing procedure has been triggered via the DVR UI 1111.

The processing unit 1120 may issue AV/C digital interface commands by operating the DV control API 1125 to direct the DV camera 1200 to perform certain tasks. These AV/C digital interface commands are transmitted through the AV/C control unit 1123 and the IEEE 1394 hardware 1121. For example, a “REWIND” command may be issued to direct transport mechanism of the DV camera 1200 to control movement of the DV/MiniDV tape 1210 toward the beginning of the DV/MiniDV tape 1210. A “PLAY” command may be issued to direct transport mechanism of the DV camera 1200 to playback video frames and/or video channels recorded on the DV/MiniDV tape 1210 at normal speed. The AV/C digital interface commands are typically encapsulated in AV/C command frames and issued to the DV camera 1200, and response messages corresponding to the issued AV/C digital interface commands are typically encapsulated in AV/C response frames and received by the DVR 1100. The recorded video frames and/or audio channels are transmitted to DVR UI 1111 and DV AV decoding hardware 1131 via the IEEE 1394 hardware 1121. The DV AV decoding hardware 1131 decodes the received video frames and/or audio channels and stores the decoding results in the buffer 1139, for use by the trans code module 1133 and display module 1141. The TVE module 1143 further encodes the decoding results in various TV (television) signal formats and outputs to a TV. The trans code module 1133 receives and converts the decoding results into data in various formats required by the recording device 1135. For example, before writing data to an optical disk, data is scrambled and Reed-Solomon (R-S) code is inserted into the scrambled data for further error correction.

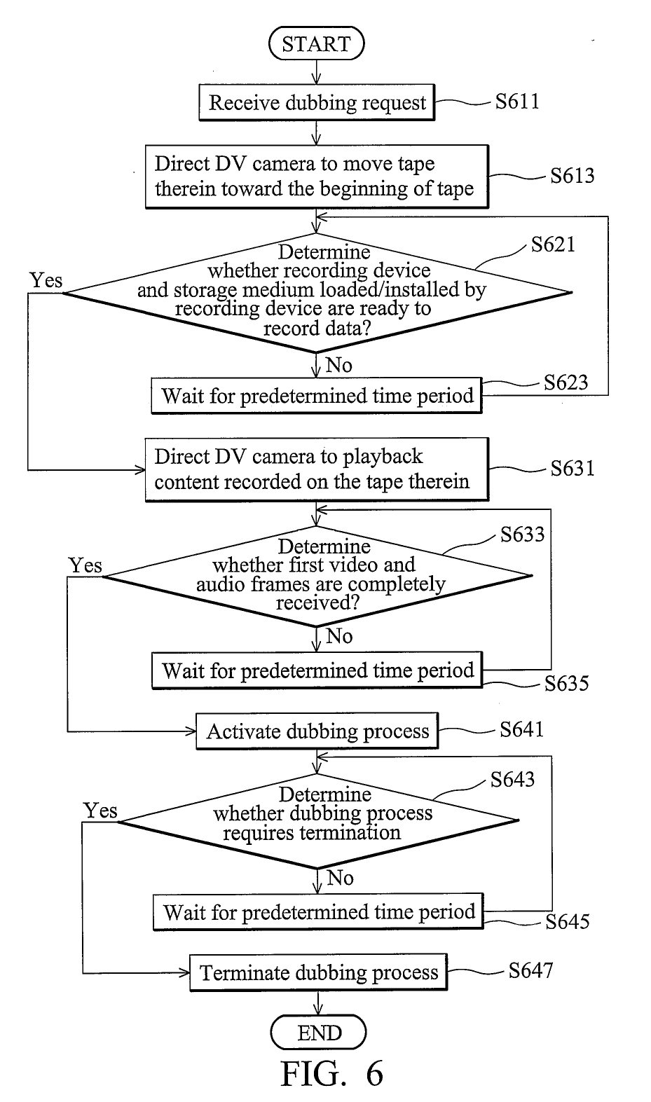

FIG. 6 is a flowchart illustrating an embodiment of a method for DV dubbing without frame loss, performed by the processing unit 1120. In step S611, a dubbing request is received. The dubbing request is preferably received from the DVR UI 1111. In step S613, the DV camera 1200 is directed to move tape therein toward the beginning of the tape. The described “REWIND” command is preferably issued to the DV camera 1200 via the DV control API 1125, AV/C control unit 1123 and IEEE 1394 hardware 1121. Step S613 may also activate and direct the recording device 1135 to perform preparation tasks for later recording. In step S621, it is determined whether the recording device 1135 and storage medium 1137 loaded/installed by the recording device 1137 are ready to record data. If so, the process proceeds to step S631, otherwise, to step S623 waiting for a predetermined time period, such as one second. For example, when a DVD recording drive is activated to record data, step S621 may collect information regarding whether a spindle of the DVD recording drive is rotated at a predetermined rotational speed, a DVD disc loaded in the DVD recording drive is recordable, a new file is successfully created in a DVD file system on the loaded DVD disc, an OPC (optical power calibration) process is successfully performed, or combination thereof, by querying relevant firmware corresponding to the DVD recording drive. It is to be understood that step S621 is periodically performed until the recording device 1135 and storage medium 1137 are ready to record data, avoiding activation of a dubbing process when the recording device 1135 and storage medium 1137 are not ready. If the dubbing process is activated and the recording device 1135 and storage medium 1137 are not ready to record data, certain video and audio frames are lost and are not recorded on the storage medium 1137.

After the recording device 1135 and recordable storage media 1137 loaded/installed in the recording device 1137 are ready to record data, step S631 is performed to direct the DV camera 1200 to playback content recorded on the tape therein. The described “PLAY” command is preferably issued to the direct transport mechanism of the DV camera 1200 to playback video frames and/or video channels recorded on the DV/MiniDV tape 1210 at normal speed. When receiving the “PLAY” command, the DV camera 1200 plays back video frames and/or audio channels, encapsulates the video frames and/or audio channels into numerous transport packets, and transmits the encapsulated transport packets to the DV AV decoding hardware 1131 via the IEEE 1394 hardware 1121. It is to be understood that the DV AV decoding hardware 1131 unpacks and assembles the received transport packets to an AV stream, separates the AV stream into video frames and audio frames, and stores the separated video frames and audio frames in the buffer 1139. After completely generating and storing the first video frame, and/or audio frame, the DV AV decoding hardware 1131 may further trigger an interrupt indicating that the first video frame, and/or audio frame is completely generated. In step S633, it is determined whether first video and audio frames are completely received. It is to be understood that the first video and audio frames represent initial AV data, and the content of initial AV data can be configured in various aspects. For example, the initial AV data may be configured to a first video frame, a first audio frame, or the both. If so, the process proceeds to step S641, otherwise, to step S635 waiting for a predetermined time period, such as one second. For example, step S633 may detect whether the described interrupt is triggered, or detect whether the first video frame, and/or audio frame have/has been stored in the buffer 1139. It is to be understood that step S633 is periodically performed until the first video frame, and audio frames are completely generated, avoiding recording of unnecessary data, such as blank video and audio frames.

After the first video and audio frames are completely generated, step S641 is performed to activate a dubbing process. When performing the dubbing process, the recording device 1135 with the trans code module 1133 acquires the buffered video and audio frames and records the acquired data on the media 1137 in a relevant format. In step S643, it is determined whether the dubbing process requires termination. If so, the process proceeds to step S647 terminating the dubbing process, otherwise, to step S645 to wait for a predetermined time period, such as one second. It is to be understood that step S643 is periodically performed until the dubbing process requires termination. An AV/C digital interface command is preferably issued to request the current state of the DV camera 1200. When receiving a response corresponding to the issued AV/C digital interface command indicates that the tape has ended or playback of the tape has stopped, it is determined that the dubbing process requires termination.

Methods for DV dubbing without frame loss, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD player, a DVD recorder, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for dubbing content recorded on a tape in a DV (digital video) camera to a DVD disc by a DVD recording device, comprising:
receiving a dubbing request;
directing the DV camera to move the tape toward the beginning of the tape by issuing a control command to the DV camera after receiving the dubbing request;
periodically determining whether the DVD recording device and the DVD disc are ready to record data; and
activating a dubbing process for recording the content from the tape on the DVD disc after determining the DVD recording device and the DVD disc are ready to record data.

2. The method as claimed in claim 1 further comprising:
directing the DV camera to playback the content recorded on the tape by issuing a control command to the DV camera after determining the DVD recording device and the DVD disc are ready to record data;
periodically determining whether the first video frame, and/or audio frame are/is completely generated in response to the playback content after directing the DV camera to playback the content; and
activating the dubbing process after determining that first video frame, and/or audio frame are/is completely generated.

3. The method as claimed in claim 2 wherein the first video frame, and/or audio frame are completely generated when receiving an interrupt indicating that the first video frame, and/or audio frame are completely generated from a DV AV (audio video) decoding hardware.

4. The method as claimed in claim 2 wherein the first video frame, and/or audio frame are completely generated when detecting that the first video frame, and/or audio frame are completely stored in a buffer.

5. The method as claimed in claim 1 wherein the content comprises a plurality of video frames, and/or a plurality of audio channels.

6. The method as claimed in claim 1 wherein the DVD recording device and the DVD disc are ready to record data when a spindle of the DVD recording device a rotated at a predetermined rotational speed, and the DVD disc is recordable.

7. The method as claimed in claim 1 wherein the DVD recording device and the DVD disc are ready to record data when a new file is successfully created in a DVD file system on the DVD disc, and the DVD disc is recordable.

8. The method as claimed in claim 1 wherein the DVD recording device and the DVD disc are ready to record data when an OPC (optical power calibration) process is successfully performed, and the DVD disc is recordable.

9. A method for dubbing content recorded on a tape in a DV (digital video) camera to a storage medium by a recording device, performed by a DVR (digital video recorder), comprising:
receiving a dubbing request;
directing the DV camera to move the tape toward the beginning of the tape by issuing a control command to the DV camera after receiving the dubbing request;
periodically determining whether the recording device of the DVR, or the storage medium installed or loaded by the recording device is ready to record data; and
activating a dubbing process for recording the content from the tape on the storage medium after determining the recording device or the storage medium is ready to record data.

10. The method as claimed in claim 9 further comprising:
directing the DV camera to playback the content recorded on the tape by issuing a control command to the DV camera after determining the recording device or the storage medium is ready to record data;
periodically determining whether initial AV data is completely generated in response to the playback content after directing the DV camera to playback the content; and
activating the dubbing process after determining that the initial AV data completely generated.

11. The method as claimed in claim 10 wherein the initial AV data comprises a first video frame, a first audio frame, or the both.

12. The method as claimed in claim 10 wherein the initial AV data is completely generated when receiving an interrupt indicating that the initial AV data is completely generated from a DV AV (audio video) decoding hardware.

13. The method as claimed in claim 10 wherein the initial AV data is completely generated when detecting that the initial AV data is completely stored in a buffer.

14. The method as claimed in claim 9 wherein the content comprises a plurality of video frames, and/or a plurality of audio channels.

15. An apparatus for dubbing content recorded on a tape in a DV (digital video) camera, comprising:
a storage medium;
a recording device loading or installing the storage medium; and
a processing unit receiving a dubbing request, directing the DV camera to move the tape toward the beginning of the tape by issuing a control command to the DV camera after receiving the dubbing request, periodically determining whether the recording device or the storage medium is ready to record data, and activating a dubbing process for recording the content from the tape on the storage medium after determining the recording device or the storage medium is ready to record data.

16. The apparatus as claimed in claim 15 wherein the processing unit directs the DV camera to playback the content recorded on the tape by issuing a control command to the DV camera after determining the recording device or the storage medium is ready to record data, periodically determines whether initial AV data is completely generated in response to the playback content after directing the DV camera to playback the content, and activates the dubbing process after determining that the initial AV data completely generated.

17. The apparatus as claimed in claim 16 wherein the initial AV data comprises a first video frame, a first audio frame, or the both.

18. The apparatus as claimed in claim 16 further comprising a DV AV (audio video) decoding hardware, wherein the processing unit determines that the initial AV data is completely generated when receiving an interrupt indicating that the initial AV data is completely generated from the DV AV (audio video) decoding hardware.

19. The apparatus as claimed in claim 16 further comprising a buffer, wherein the processing unit determines that the initial AV data is completely generated when detecting that the initial AV data is completely stored in a buffer.

20. The apparatus as claimed in claim 15 wherein the DV camera and the DVR are connected via an IEEE 1394 link.

21. The apparatus as claimed in claim 15 further comprising a button disposed on a front panel of an enclosure, wherein the dubbing request is received when detecting that the button is pressed.

22. The apparatus as claimed in claim 15 further comprising a IR (infrared receiver) module, wherein the dubbing request is received when the IR module receives infrared signals instructing that a DV dubbing procedure is triggered by a user from a DVR remote controller.
